(19) United States
(12) Patent Application Publication
(10) Pub. No.: US 2026/0347578 A1
(43) Pub. Date: Nov. 5, 2026

(54) SOLID TIRE FOR A TRAVELLING ROLLER, COMPRISING A RUBBER COMPOSITION

(71) Applicant: COMPAGNIE GENERALE DES ETABLISSEMENTS MICHELIN, Clermont-Ferrand (FR)

(72) Inventor: GUILLAUME HENNEBERT, Clermont-Ferrand (FR)

(21) Appl. No.: 19/121,526

(22) PCT Filed: Oct. 17, 2023
(86) PCT No.: PCT/EP2023/078743

§ 371 Date: Apr. 16, 2025

(30) Foreign Application Priority Data
Oct. 20, 2022 (FR) FR2210851

(51) Int. Cl. C08L 9/00; B60C 1/00; C08K 3/04; C08K 5/01; C08K 5/18; C08K 5/3437

(52) U.S. Cl. CPC C08L 9/00; B60C 1/00; C08K 3/04; C08K 5/01; C08K 5/18; C08K 5/3437; B60C 2001/0091

(57) ABSTRACT

A solid tire for a running roller for a cable transportation installation exhibits an improved lifetime, which makes it possible to withstand major loads and which makes it possible to reduce the energy consumption of the installation. The solid tire comprises a rubber composition based on at least one elastomer matrix comprising from 25 to 95 phr of polybutadiene and from 5 to 75 phr of polyisoprene comprising a content by weight of cis-1,4-bonds of at least 90% of the weight of the polyisoprene, a reinforcing filler and a crosslinking system. A cable transportation installation may comprise at least one running roller comprising this solid tire.

The present invention relates to a solid tyre made of rubber composition for a running roller of a cable transportation installation, such as cableways or cable cars.

The transportation of people or goods by cable, for example by means such as cableways, cable cars or chairlifts, is widely used in mountainous areas and is undergoing significant development in the urban transportation sector, where this transportation system exhibits many advantages. In particular, it is not very intrusive because the ground surface area is small, and it is relatively quiet in comparison with a bus or tram line.

Among the criteria which are decisive in the choice of a cable transportation solution, the maximum transportation capacity, expressed in kilograms and/or in number of people per hour, is a particularly important criterion. The transportation capacity is a combination of different parameters, such as:
the size of the cabins, which are capable of each carrying a greater or lesser number of people or of goods. The overall weight of cabins and of their loading with people or goods is added to the weight of the cable, the dimensions of which also depend on the weight of the cabins. Thus, the load to be carried increases overall with the size of the cabins.
the density of the cabins, that is to say the spacing between two successive cabins. The closer together the cabins, the higher the linear load and thus the greater the load to be carried.
the speed of forward progression of the cable, which defines the loading-unloading rate of the cabins and determines the maximum capacity of the, for example cableway, line.

The overall weight of an aerial transportation line is usually supported by a series of pylons, each comprising a greater or lesser number of rollers. Each roller is covered with a layer of elastomer in order to provide the passengers with a degree of comfort or to keep the cargo intact, and to preserve the structure of the cable. This is because the cable is a fundamental element of the safety of this type of means of transportation and it must not be harmed, worn or damaged by the repeated contacts with the numerous rollers. This elastomer part, called a tyre, is in accordance with regulations limited in modulus in order not to harm the cable.

One of the concerns of installers of a cable transportation line is to reduce the number of rollers as much as possible. This is because, from an economic viewpoint, any additional roller brings about two major sources of costs:
the number of pylons, which increases while the supporting capacity of a pylon (loading and number of rollers per pylon head) remains the same. Beyond the cost, any additional pylon also leads to greater installation constraints;
the system of distributing the load between all the rollers of a pylon head is increasingly complex and expensive when the number of rollers increases.

Thus, having available a roller with a greater load-bearing capacity would make it possible to make aerial transportation systems more efficient and thus more competitive. The element limiting this feature is the rubber tyre which provides contact with the cable and which is thus squashed by the load to be carried. To increase the load-bearing capacity, it would be advantageous to increase the stiffness of the rubber compositions constituting the tyre.

Another major challenge concerning cable transportation installations is that of reducing as much as possible the energy consumption necessary for their operation. For this, it would be advantageous to reduce the hysteresis of the rubber compositions constituting the tyre.

Furthermore, the tyres have a lifetime which can reach several years in the case of mountain operation in particular. For urban cable transportation lines, this lifetime can be much shorter as a result of the virtually continuous rate of use and of a broad daily hourly amplitude. This stress implies a rise in temperature of the rubber composition, which contributes to the reduction of the lifetime of the tyre. In some, most severe, cases, the lifetime of a tyre may be only approximately three months. This penalizes the operator of the transportation line in two aspects: the loss of operation and of service to the user as a result of maintenance stoppages, and the cost associated with the operations of maintenance and of purchase of tyres.

Having available low-hysteresis compositions would make it possible to limit the heating of the rubber tyres and thus to increase their lifetime.

In point of fact, it is recognized that it is particularly difficult to find solutions which make it possible to improve the compromise between the stiffness and the hysteresis.

Currently, rubber compositions for cable transportation installation tyres are mainly composed of a mixture of polybutadiene and of butadiene-styrene copolymer, as is presented in JP2007284509 and JP2021088659, which propose to use specific carbon blacks to improve the wear resistance of the rubber composition of the roller while reducing its hysteresis.

However, it remains necessary to further improve the hysteresis and the stiffness of the running roller rubber compositions for a cable transportation installation in order to make it possible for it to increase its load-bearing capacity, to extend its lifetime and to reduce the energy consumption of the installation.

On continuing its research studies, the Applicant Company has discovered, unexpectedly, that the combined use of polybutadiene and of polyisoprene makes it possible to further improve the abovementioned compromise in performance qualities.

Thus, a subject-matter of the invention is a solid tyre of a running roller for a cable transportation installation, the solid tyre comprising a rubber composition based on at least one elastomer matrix comprising from 25 to 95 phr of polybutadiene and from 5 to 75 phr of polyisoprene comprising a content by weight of cis-1,4-bonds of at least 90% of the weight of the polyisoprene, a reinforcing filler and a crosslinking system.

The invention also relates to a cable transportation installation comprising at least one running roller comprising a tyre according to the invention.

### I—DEFINITIONS

The expression “composition based on” should be understood as meaning a composition comprising the mixture and/or the product of the in situ reaction of the various constituents used, it being possible for some of these constituents to react and/or to be intended to react with each other, at least partially, during the various phases of manufacture of the composition; it thus being possible for the composition to be in the completely or partially crosslinked state or in the non-crosslinked state.

The term “elastomer matrix” is understood to mean the combination of the elastomers of the composition.

Within the meaning of the present invention, the expression “part by weight per hundred parts by weight of elastomer” (or phr) should be understood as meaning the part by weight per hundred parts of elastomer present in the rubber composition under consideration.

In the present document, unless expressly indicated otherwise, all the percentages (%) shown are percentages (%) by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b). In the present document, when an interval of values is denoted by the expression “from a to b”, the interval represented by the expression “between a and b” is also and preferentially denoted.

The compounds mentioned in the description can be of fossil origin or be biobased. In the latter case, they can result, partially or completely, from biomass or be obtained, partially or completely, from renewable starting materials resulting from biomass. In the same way, the compounds mentioned can also originate from the recycling of pre-used materials, that is to say that they can, partially or completely, result from a recycling process, or else be obtained, partially or completely, from starting materials which themselves result from a recycling process. Polymers, plasticizers, fillers, and the like, are concerned in particular.

Unless otherwise indicated, all the glass transition temperature “Tg” values described in the present document are measured in a known way by DSC (Differential Scanning calorimetry) according to Standard ASTM D3418 (1999).

### II—BRIEF DESCRIPTION OF THE FIGURES

All the implementational details are given in the description which follows, which is supplemented by FIGS. 1 to 4, which are presented solely by way of non-limiting examples and in which:

FIG. 1 is a diagrammatic representation of an example of a tyre in transverse view.

FIG. 2 is a cross-section of the tyre of FIG. 1.

FIG. 3 is a diagrammatic representation of an example of a roller, comprising a tyre fitted to a wheel, in transverse view.

FIG. 4 is a cross-section of the roller of FIG. 3.

### III—DESCRIPTION OF THE INVENTION

### III-1 Running Roller Solid Tyre

In a known way, a solid tyre of a running roller for a cable transportation installation is attached around the metal hub of the roller and held in place by a mechanical fastening and clamping system.

The architecture of a solid tyre conventionally comprises:
a volume of rubber forming the main body of the tyre, filling the space between the metal parts of the hub on which the tyre is assembled and forming a groove profile for the interface with the cable, and
a clamping belt at the bore of the tyre produced by winding several layers of a non-metallic cord reinforcement.

Such solid tyres and their process of manufacture are described, for example, in the document JP2007284509.

Other architectures have also been developed to increase the lifetime of solid tyres and the load which they can withstand. They can, for example, be solid tyres comprising a bulk body made of elastomer material and at least one annular insert, which is preferably monolithic (that is to say, preferentially made of a single piece, without reinforcing yarns or cords, or fabric), arranged radially inside the bulk body. Such tyres and their process of manufacture are described in the document WO 2020/208575 A1.

The solid tyres of the invention are not limited to a particular architecture and can thus be used for any type of running roller for a cable transportation installation.

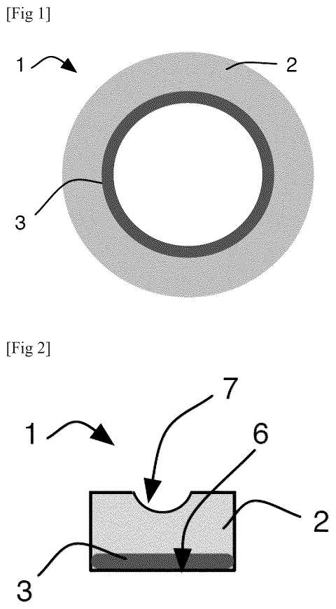

FIGS. 1 to 4 illustrate a non-limiting example of a tyre and of a roller. In particular, FIGS. 1 and 2 illustrate an example of a tyre alone. The tyre 1 comprises a solid bulk body 2 made of rubber and a preferably monolithic annular insert 3 made of a different material from that of the bulk body. It might alternatively comprise a solid bulk body made of rubber comprising textile reinforcements in the radially innermost zone (not represented) but without an annular insert. As illustrated in FIGS. 2 and 4, the tyre comprises a groove forming a running zone 7 for the cable. The presence of this zone promotes straight and even running, despite the lateral stresses, such as the wind, which can tend to displace the cabins or seats of the cableway and thus to shift the cable onto one of the edges of the running surface of the tyre. Preferably, the depth of the groove of the tyre is at least equal to 40% of the diameter of the carrier cable which is intended to come into contact with the running surface of the tyre.

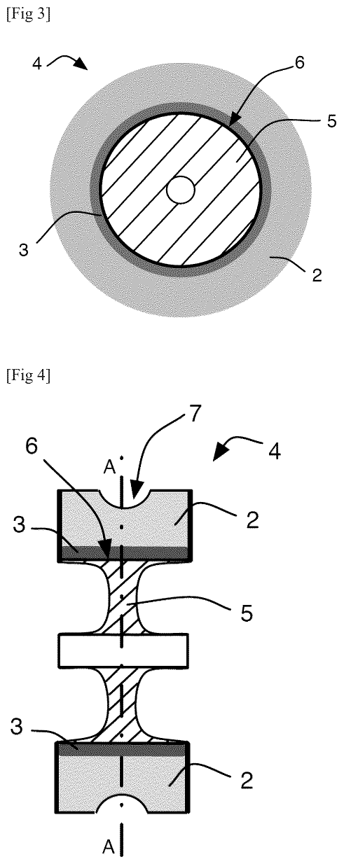

FIGS. 3 and 4 illustrate a non-limiting example of a roller 4, with a tyre 1 fitted to a wheel 5, the external surface of which forms a supporting surface 6 for the tyre.

The annular insert 3 is arranged radially inside the bulk body 2. In the example of FIGS. 1 and 2, the insert has a substantially rectangular transverse profile, as shown in FIGS. 2 and 4. In this example, it occupies the entire radially inner zone of the tyre.

The composition of the bulk body 2 is produced with the rubber composition of the solid tyre 1 of a running roller 4 for a cable transportation installation of the invention and described in detail below. A person skilled in the art will easily understand that when the composition of the solid tyre 1 according to the invention advantageously denotes all or part of the composition of the bulk body 2.

The solid tyre 1 can be a solid tyre of a cable transportation installation selected from the group consisting of cableways, cable cars, chairlifts, ski lifts and funitels. Preferably, the solid tyre 1 can be a solid tyre of a cable transportation installation selected from the group consisting of cableways and cable cars.

The invention also relates to a cable transportation installation comprising at least one running roller comprising a tyre according to the invention, the cable transportation installation preferably being selected from the group consisting of cableways, cable cars, chairlifts, ski lifts and funitels, preferably selected from the group consisting of cableways and cable cars.

The cableways can in particular be double-track to-and-fro, single-track to-and-fro, pulsed, disengageable 2S or 3S cableways. Preferably, the solid tyre 1 is a solid cableway tyre, preferably a solid 2S or 3S cableway tyre.

### III—2 Elastomer Matrix

According to the invention, the elastomer matrix of the rubber composition of the solid tyre is based on at least one elastomer matrix comprising from 25 to 95 phr of polybutadiene and from 5 to 75 phr of polyisoprene comprising a content by weight of cis-1,4-bonds of at least 90% of the weight of the polyisoprene.

The term “polybutadiene” (abbreviated to “BR”) will be understood as meaning that it can concern one or more polybutadienes. Polybutadiene is a well-known rubber which is manufactured 1 by polymerizing the 1,3-butadiene monomer (typically a homopolymerization) in a solution polymerization process while using appropriate catalysts known to a person skilled in the art. Due to the two double bonds present in the butadiene monomer, the resulting polybutadiene can comprise three different forms: a cis-1,4-polybutadiene, trans-1,4-polybutadiene and 1,2-vinyl. The cis-1,4- and trans-1,4-elastomers are formed by the monomers connecting end to end, while the 1,2-vinyl elastomer is formed by the monomers connecting between the ends of the monomer. The choice of the catalyst and the temperature of the process are known as the variables generally used to control the content of cis-1,4-bonds of the polybutadiene.

Advantageously, the polybutadiene exhibits a content (molar %) of cis-1,4-linkages of greater than 55%, preferably of greater than 90%, more preferentially of greater than 95%.

The content of the polybutadiene in the rubber composition of the solid tyre according to the invention is preferably within a range extending from 45 to 90 phr, preferably from 55 to 80 phr.

The content of the polyisoprene comprising a content by weight of cis-1,4-bonds of at least 90% of the weight of the polyisoprene, in the rubber composition of the solid tyre according to the invention, is preferably within a range extending from 15 to 55 phr, preferably from 20 to 45 phr.

The polyisoprene comprising a content by weight of cis-1,4-bonds of at least 90% of the weight of the polyisoprene is preferably selected from the group consisting of natural rubber, synthetic polyisoprenes and their mixtures; preferably, a natural rubber is concerned.

In a particularly advantageous way, the rubber composition of the solid tyre according to the invention comprises from 55 to 80 phr of polybutadiene and from 20 to 45 phr of natural rubber.

Advantageously, the total content of the polybutadiene and of the polyisoprene (preferably natural rubber) represents at least 75% by weight of the elastomer matrix of the rubber composition, preferably at least 80%, preferably at least 90%, by weight, of the elastomer matrix of the rubber composition of the solid tyre according to the invention. More preferably, the total content of the polybutadiene and of the polyisoprene (preferably natural rubber) represents 100% by weight of the elastomer matrix of the rubber composition of the solid tyre according to the invention.

When the rubber composition of the tyre comprises another elastomer than polybutadiene or polyisoprene comprising a content by weight of cis-1,4-bonds of at least 90% of the weight of the polyisoprene, that is to say when the total content of the polybutadiene and of the polyisoprene is less than 100% by weight of the elastomer matrix, the elastomer can be selected from the group consisting of butadiene copolymers, isoprene copolymers and the mixtures of these elastomers. The butadiene copolymers are in particular selected from the group consisting of butadiene-styrene copolymers (SBRs).

### III—3 Reinforcing Filler

The rubber composition of the tyre according to the invention is based on at least one reinforcing filler. Such a reinforcing filler typically consists of nanoparticles, the (weight-) average size of which is less than a micrometre, generally less than 500 nm, most often between 20 and 200 nm, in particular and more preferentially between 20 and 150 nm.

The reinforcing filler can comprise carbon black, silica or one of their mixtures. Advantageously, the reinforcing filler of the composition according to the invention comprises more than 50% by weight, preferably more than 80% by weight, of carbon black. More preferably, the reinforcing filler consists exclusively of carbon black, that is to say that carbon black represents 100% by weight of the reinforcing filler.

Suitable as carbon blacks are all carbon blacks, in particular the blacks conventionally used in tyres or their treads. Among the latter, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks can be used in the isolated state, as available commercially, or in any other form, for example as support for some of the rubber additives used. The carbon blacks might, for example, be already incorporated in the diene elastomer, in particular isoprene elastomer, in the form of a masterbatch (see, for example, Applications WO97/36724-A2 and WO99/16600-A1).

Among the abovementioned carbon blacks, those exhibiting a BET specific surface within a range extending from 33 to 69 m²/g, preferably from 33 to 60 m²/g, preferably from 40 to 49 m²/g, are particularly preferred.

The BET specific surface of the carbon blacks is measured according to Standard ASTM D6556-10 [multipoint (a minimum of 5 points) method-gas: nitrogen-relative pressure p/po range: 0.1 to 0.3].

Any type of precipitated silica, in particular highly dispersible precipitated silicas (referred to as “HDSs”), may be suitable as silicas. These precipitated silicas, which are or are not highly dispersible, are well known to a person skilled in the art. Mention may be made, for example, of the silicas described in Applications WO03/016215-A1 and WO03/016387-A1. Among the commercial HDS silicas, use may in particular be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G (-D), Hi-Sil EZ160G (-D), Hi-Sil EZ200G (-D), Hi-Sil 243LD, Hi-Sil 210 and Hi-Sil HDP 320G silicas from PPG.

In order to couple the silica to the diene elastomer, use may be made, in a well-known way, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound possessing a first functional group capable of interacting with the inorganic filler and a second functional group capable of interacting with the diene elastomer. For example, such a bifunctional compound can comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, when they are used, the organosilanes are selected from the group consisting of (symmetrical or asymmetrical) organosilane polysulfides, such as bis(3-triethoxysilylpropyl)tetrasulfide, abbreviated to TESPT, sold under the name Si69 by Evonik, or bis(3-triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl) propyl) octanethioate, sold by Momentive under the name NXT Silane. More preferentially, the organosilane is an organosilane polysulfide.

When an agent for coupling the silica to the elastomer is used, the content of coupling agent can easily be adjusted by a person skilled in the art. Typically, the content of coupling agent represents from 0.5% to 15% by weight, with respect to the amount of silica.

The content of reinforcing filler can be easily adjusted by a person skilled in the art according to the use of the rubber composition. Advantageously, the content of reinforcing filler in the composition according to the invention is within a range extending from 45 to 85 phr, preferably from 50 to 80 phr, preferably from 55 to 70 phr.

Preferably, the content of carbon black in the composition according to the invention is within a range extending from 45 to 85 phr, preferably from 50 to 80 phr, preferably from 55 to 70 phr, and the composition does not comprise a filler other than carbon black or comprises less than 10 phr, preferably less than 5 phr, of it; more preferably, the composition does not comprise a filler other than carbon black.

### III—4 Crosslinking System

The crosslinking system can be any type of system known to a person skilled in the art in the field of rubber compositions for tyres. It can in particular be based on sulfur and/or on peroxide and/or on bismaleimides.

Preferentially, the crosslinking system is based on sulfur; it is then referred to as a vulcanization system. Advantageously, the vulcanization system comprises molecular sulfur and/or at least one sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or also known vulcanization retarders.

Sulfur is used at a preferential content of between 0.5 and 12 phr, in particular between 1 and 10 phr. The vulcanization accelerator is used at a preferential content of between 0.5 and 10 phr, more preferentially of between 0.5 and 5.0 phr.

Use may be made, as accelerator, of any compound capable of acting as accelerator of the vulcanization of diene elastomers in the presence of sulfur, in particular accelerators of the thiazole type, and also their derivatives, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

### III—5 Possible Additives

The running roller rubber compositions for a cable transportation installation according to the invention can optionally also comprise all or part of the usual additives normally used in elastomer compositions for a running roller comprising a rubber composition, such as, for example, protective agents, such as antiozonants, antioxidants, anti-fatigue agents, pigments, and the like.

Advantageously, the rubber composition of the solid tyre comprises at least one antioxidant, preferably at a content within a range extending from 3 to 10 phr, preferably from 4 to 9 phr, preferably from 5 to 8 phr.

The at least one antioxidant is preferably selected from the group consisting of N-(1,3-dimethylbutyl)-N′-phenyl-1,4-phenylenediamine, 2,2,4-trimethyl-1,2-dihydroquinoline, 2,2′-methylenebis(6-tert-butyl-4-methylphenol), N,N′-diphenyl-p-phenylenediamine, 2,6-di(tert-butyl)-4-methylphenol, N-isopropyl-N′-phenyl-1,4-phenylenediamine, 3,9-di(3-cyclohexen-1-yl)-2,4,8,10-tetraoxaspiro[5.5]undecane, bis(1-octyloxy-2,2,6,6-tetramethyl-4-piperidyl) sebacate, octyl 3-[3-(2H-benzotriazol-2-yl)-5-tert-butyl-4-hydroxyphenyl]propanoate, methyl-2-mercaptobenzimidazole and their mixture. More preferably, the at least one antioxidant is selected from the group consisting of N-(1,3-dimethylbutyl)-N′-phenyl-1,4-phenylenediamine, 2,2,4-trimethyl-1,2-dihydroquinoline and their mixture.

Such antioxidants are commercially available, for example under the name Santoflex 6-PPD sold by Flexsys or under the name Pilnox TMQ sold by Lanxess.

Advantageously also, the rubber composition of the solid tyre comprises at least one antiozonant well known to a person skilled in the art.

The antiozonant which can be used in the context of the present invention can be, in particular, a natural wax, a synthetic wax or a mixture of natural wax and of synthetic wax. For example, the antiozonant can be a natural wax selected from the group consisting of mineral waxes, such as paraffin waxes, vegetable waxes, animal waxes and their mixtures. The antiozonant can also be a synthetic wax selected from the group consisting of Fischer-Tropsch waxes, polyethylene waxes and their mixtures.

Advantageously, the antiozonant is selected from the group consisting of paraffin waxes, Fischer-Tropsch waxes and their mixtures. Preferably, the antiozonant is a paraffin wax or a mixture of paraffin waxes.

Advantageously, the antiozonant predominantly comprises linear or branched hydrocarbon chains, the number of carbon atoms of which is within a range extending from 18 to 70, preferably from 18 to 65, more preferably from 18 to 60, preferably from 18 to 55, preferably from 18 to 50, preferably from 22 to 38. Preferably, the hydrocarbon chains of the antiozonant are essentially saturated. In the context of the present invention, the term “essentially saturated” is understood to mean a content of diene unit of less than 15%, preferably of less than 10%, preferably of less than 5%, for example 0%.

The branched (iso)/unbranched (normal) hydrocarbon chains ratio in the antiozonant can be within a range extending from 0/100 to 80/20, preferably from 5/95 to 65/35, more preferably from 5/95 to 35/65, more preferentially still from 5/95 to 20/80.

Such antiozonants are commercially available, for example the Redezon waxes (for example the 500, PWM-80, 7335-G and 7812 series) from Repsol, the Varazon waxes (for example the 5998, 4959 and 6810 series) from Sasol, the Ozoace 0355 wax from Nippon Seiro and the OK2122 or OK5258H wax from Paramelt Co. Ltd.

Preferably, the content of the at least one antiozonant in the rubber composition of the solid tyre is within a range extending from 1 to 3 phr.

### III—6 Preparation of the Rubber Compositions

The rubber compositions for a solid roller tyre in accordance with the invention can be manufactured in appropriate mixers, using two successive preparation phases well known to a person skilled in the art:
a first phase of thermomechanical working or kneading (“non-productive” phase), which can be carried out in a single thermomechanical stage during which all the necessary constituents, in particular the elastomer matrix, the reinforcing filler and the optional various other additives, with the exception of the crosslinking system, are introduced into an appropriate mixer, such as a standard internal mixer (for example of Banbury type). The incorporation of the optional filler in the elastomer can be carried out in one or more goes while kneading thermomechanically. In the case where the filler is already incorporated, in all or in part, in the elastomer in the form of a masterbatch, as is described, for example, in Applications WO 97/36724 and WO 99/16600, it is the masterbatch which is directly kneaded and, if appropriate, the other elastomers or fillers present in the composition which are not in the masterbatch form, and also the optional various other additives, other than the crosslinking system, are incorporated. The non-productive phase can be carried out at high temperature, up to a maximum temperature of between 110 °C and 200 °C, preferably between 130 °C and 185 °C, for a period of time generally of between 2 and 10 minutes.
a second phase of mechanical working (“productive” phase), which can be carried out in an external mixer, such as an open mill, after cooling the mixture obtained during the first non-productive phase down to a lower temperature, typically of less than 120 °C, for example between 40 °C and 100 °C. The crosslinking system is then incorporated and everything is then mixed for a few minutes, for example between 5 and 15 min.

Such phases have been described, for example, in Applications EP-A-0 501 227, EP-A-0 735 088, EP-A-0 810 258, WO00/05300 and WO00/05301.

The final composition thus obtained is subsequently calendered, for example in the form of a sheet or of a plaque, in particular for laboratory characterization, or also extruded (or co-extruded with another rubber composition) in the form of a rubber semi-finished product (or profiled element) which can be used, for example, as solid tyre of a running roller for a cable transportation installation. These products can subsequently be used for the manufacture of tyres, according to the techniques known to a person skilled in the art.

The composition can be either in the raw state (before crosslinking or vulcanization) or in the cured state (after crosslinking or vulcanization).

The crosslinking of the composition can be carried out in a way known to a person skilled in the art, for example at a temperature of between 130 °C and 200 °C, under pressure.

### IV—EXAMPLES

### IV—1 Measurements and Tests Used

### Dynamic Properties

The dynamic properties G* and tan (δ)ₘₐₓ are measured on a viscosity analyser (Metravib VA4000) according to Standard ASTM D5992-96. The response is recorded of a sample of vulcanized composition (cylindrical test specimen with a height of 4 mm and a cross section of 400 mm²), subjected to a simple alternating sinusoidal shear stress, at a frequency of 10 Hz, under a stress of 0.7 MPa. A temperature sweep is carried out at a constant rate of temperature rise of +1.5 °C/min and the values of G* and tan (δ)ₘₐₓ at 60 °C are recorded.

The results for G* at 60 °C are expressed in base performance 100, the value 100 being assigned to the control. A result of greater than 100 indicates that the composition of the example under consideration is stiffer, reflecting an improved capacity to withstand heavy loads.

The results for tan (δ)ₘₐₓ at 60 °C are expressed in base performance 100, the value 100 being assigned to the control. A result of greater than 100 indicates that the composition of the example under consideration has a lower hysteresis, reflecting a lower rolling resistance of the tyre comprising such a composition.

### IV—2 Preparation of the Compositions

In the examples which follow, the rubber compositions were produced as described in point III.6 above. In particular, the “non-productive” phase was carried out in a 3.2 litre mixer for 4.5 minutes, for a mean speed of the blades of 45 revolutions per minute, until a maximum dropping temperature of 165 °C was reached. The “productive” phase was carried out in an open mill at 40 °C for 5 minutes.

The crosslinking of the composition was carried out at a temperature of at 150 °C, under pressure.

### IV—3 Rubber Tests

The object of the examples presented below is to compare the compromise in performance between the rolling resistance and the stiffness of compositions in accordance with the present invention (I1 to I4) with two control compositions (C1 and C2).

The compositions tested (in phr), and also the results obtained, are presented in Table 1.

The control composition C2 differs from the control composition C1 only in that the polybutadiene was replaced by natural polyisoprene. The composition 12 differs from the control composition C1 only in that the butadiene-styrene copolymer was replaced by natural polyisoprene.

The compositions 11, 13 and 14 make it possible to study the effect of the respective variation in the amounts of polybutadiene and of polyisoprene.

The results for hysteresis and stiffness performance qualities at 60 °C are expressed as base percentage 100, with respect to the control composition C1.

The compromise in performance qualities between the rolling resistance and the stiffness is expressed by the arithmetic mean of the results presented in base 100.

TABLE 1

| | C1 | C2 | I1 | I2 | I3 | I4 |
|---|---|---|---|---|---|---|
| Compositions | | | | | | |
| BR (1) | 50 | — | 30 | 50 | 70 | 90 |
| SBR (2) | 50 | 50 | | | | |
| NR (3) | — | 50 | 70 | 50 | 30 | 10 |
| N550 (4) | 65 | 65 | 65 | 65 | 65 | 65 |
| Antiozonant (5) | 1.5 | 1.5 | 1.5 | 1.5 | 1.5 | 1.5 |
| Antioxidant 1 (6) | 5 | 5 | 5 | 5 | 5 | 5 |
| Antioxidant 2 (7) | 2.5 | 2.5 | 2.5 | 2.5 | 2.5 | 2.5 |
| Stearic acid (8) | 3 | 3 | 3 | 3 | 3 | 3 |
| ZnO (9) | 4 | 4 | 4 | 4 | 4 | 4 |
| CBS (10) | 3.6 | 3.6 | 3.6 | 3.6 | 3.6 | 3.6 |
| CTP (11) | 0.4 | 0.4 | 0.4 | 0.4 | 0.4 | 0.4 |
| Sulfur | 1.8 | 1.8 | 1.8 | 1.8 | 1.8 | 1.8 |
| Properties | | | | | | |
| G* at 60 °C | 100 | 88 | 101 | 105 | 112 | 114 |
| Tan (δ) at 60 °C | 100 | 79 | 106 | 106 | 127 | 143 |
| Stiffness/hysteresis | 100 | 83.5 | 103.5 | 105.5 | 119.5 | 128.5 |
| compromise | | | | | | |

(1) Neodymium polybutadiene 98% cis-1,4-; Tg = −108 °C
(2) SBR, Europrene ® 1500 from Versalis
(3) Natural rubber
(4) Carbon black of N550 grade according to Standard ASTM D-1765
(5) Anti-ozone wax, Varazon 4959 from Sasol Wax
(6) N-(1,3-Dimethylbutyl)-N′-phenyl-para-phenylenediamine, Santoflex 6-PPD from Flexsys
(7) 2,2,4-Trimethyl-1,2-dihydroquinoline, Pilnox TMQ from Lanxess
(8) Stearic acid, Pristerene 4931 from Uniqema
(9) Zinc oxide of industrial grade from Umicore
(10) N-Cyclohexyl-2-benzothiazolesulfenamide, Santocure CBS from Flexsys
(11) N-Cyclohexylthiophthalimide (CTP), sold under the name Vulkalent G by Lanxess

The results presented in Table 1 above show that the compositions in accordance with the invention all improve the rolling resistance without impacting the stiffness, indeed even while improving it. The compositions 13 and 14, comprising more polybutadiene than polyisoprene, exhibit particularly noteworthy results.

1.-15. (canceled)

16. A solid tire of a running roller for a cable transportation installation, the solid tire comprising a rubber composition based on at least one elastomer matrix comprising from 25 to 95 phr of polybutadiene and from 5 to 75 phr of polyisoprene comprising a content by weight of cis-1,4-bonds of at least 90% of a weight of the polyisoprene, a reinforcing filler and a crosslinking system.

17. The solid tire according to claim 16, wherein a content of the polybutadiene in the rubber composition is within a range extending from 45 to 90 phr.

18. The solid tire according to claim 16, wherein a content of the polyisoprene in the rubber composition is within a range extending from 15 to 55 phr.

19. The solid tire according to claim 16, wherein a total content of the polybutadiene and of the polyisoprene represents at least 75% by weight of the elastomer matrix of the rubber composition.

20. The solid tire according to claim 16, wherein a total content of the polybutadiene and of the polyisoprene represents 100% by weight of the elastomer matrix of the rubber composition.

21. The solid tire according to claim 16, wherein the polyisoprene is selected from the group consisting of natural rubber, synthetic polyisoprenes and mixtures thereof.

22. The solid tire according to claim 16, wherein the rubber composition comprises from 55 to 80 phr of polybutadiene and from 20 to 45 phr of natural rubber.

23. The solid tire according to claim 16, wherein the reinforcing filler comprises more than 50% by weight of carbon black.

24. The solid tire according to claim 16, wherein a content of reinforcing filler in the rubber composition is within a range extending from 45 to 85 phr.

25. The solid tire according to claim 16, wherein the rubber composition further comprises at least one antioxidant.

26. The solid tire according to claim 25, wherein the at least one antioxidant is present at a content within a range extending from 3 to 10 phr.

27. The solid tire according to claim 25, wherein the at least one antioxidant is selected from the group consisting of N-(1,3-dimethylbutyl)-N′-phenyl-1,4-phenylenediamine, 2,2,4-trimethyl-1,2-dihydroquinoline, 2,2′-methylenebis(6-tert-butyl-4-methylphenol), N,N′-diphenyl-p-phenylenediamine, 2,6-di(tert-butyl)-4-methylphenol, N-isopropyl-N′-phenyl-1,4-phenylenediamine, 3,9-di(3-cyclohexen-1-yl)-2,4,8,10-tetraoxaspiro[5.5]undecane, bis(1-octyloxy-2,2,6,6-tetramethyl-4-piperidyl) sebacate, octyl 3-[3-(2H-benzotriazol-2-yl)-5-tert-butyl-4-hydroxyphenyl]propanoate, methyl-2-mercaptobenzimidazole and mixtures thereof.

28. The solid tire according to claim 16, wherein the rubber composition further comprises at least one antiozonant.

29. The solid tire according to claim 28, wherein the at least one antiozonant is present at a content within a range extending from 1 to 3 phr.

30. The solid tire according to claim 16, wherein the crosslinking system is based on molecular sulfur and/or on at least one sulfur-donating agent.

31. The solid tire according to claim 16, wherein the solid tire is a solid tire of a cable transportation installation selected from the group consisting of cableways, cable cars, chairlifts, ski lifts and funitels.

32. A cable transportation installation comprising at least one running roller comprising the solid tyre according to claim 16.
